(19) United States
(12) Patent Application Publication
(10) Pub. No.: US 2015/0201387 A1
(43) Pub. Date: Jul. 16, 2015

(54) Radio Frequency (RF) Attenuation Functions for Specific Absorption Rate (SAR) Compliance

(71) Applicant: Microsoft Corporation, Redmond, WA (US)

(72) Inventors: Charbel Khawand, Sammamish, WA (US); Sean Russell Mercer, Issaquah, WA (US)

(73) Assignee: Microsoft Corporation, Redmond, WA (US)

(21) Appl. No.: 14/152,086

(22) Filed: Jan. 10, 2014

(51) Int. Cl. H04W 52/26

(52) U.S. Cl. CPC H04W 52/265

(57) ABSTRACT

Radio Frequency (RF) attenuation function techniques are described for intelligently modifying the performance of radio devices to maintain specific absorption rate (SAR) compliance with regulatory requirements while minimally perturbing antennas/radio operations. A mobile computing device is configured to implement attenuation functions that reflect relationships established between transmission power and back-off amounts for different operational contexts. Rather than setting a fixed back-off for power reductions, an appropriate attenuation function that matches a current operational context of the device is used to make variable adjustments to RF power (e.g., “back-offs”). The mobile computing device may compute back-off values on demand using the functions or look-up pre-computed values from a table or other data structure. The mobile computing device may also be configured to interact with a base station to identify an amount of back-off to apply that is determined by the base station on behalf of the device.

### BACKGROUND

Mobile computing devices have been developed to increase the functionality that is made available to users in a mobile setting. For example, a user may interact with a mobile phone, tablet computer, or other mobile computing device to check email, surf the web, compose texts, interact with applications, and so on. Modern mobile computing devices may incorporate multiple antennas to support various wireless subsystems and communications. The multiple antennas may include for example one or more cellular, Wi-Fi, Bluetooth, and/or near field communication (NFC) antennas.

One challenge faced by mobile computing device designers is adherence to regulatory requirements that are imposed by entities such as the Federal Communication Commission (FCC), the European Union (EU), and so forth. An example of such regulatory requirements is legal limits on Specific Absorption Rate (SAR) that are established in relation to radio frequency (RF) energy associated with the various wireless and communications subsystems of a mobile computing device. A traditional solution for achieving compliance with SAR limits involves setting a fixed maximum RF transmit power for communication hardware (e.g., radios) to a power level that maintains legal compliance in the presence of a user. However, placing such a fixed maximum on the transmit power underutilizes the capabilities of communication hardware and may adversely affect communication connections and/or quality. Thus, traditional techniques for SAR compliance may be inadequate for some device configurations and use scenarios.

### SUMMARY

Radio Frequency (RF) attenuation function techniques are described for intelligently modifying the performance of radio devices to maintain specific absorption rate (SAR) compliance with regulatory requirements while minimally perturbing antennas/radio operations. In one or more implementations, a mobile computing device is configured to implement one or more attenuation functions to maintain compliance. The attenuation functions reflect relationships established between transmission power and RF back-off for different operational contexts. Rather than setting a fixed back-off for power reductions, an appropriate attenuation function that matches an operational context for a wireless communication in which a device is engaged may be selected and applied to make variable adjustments to RF power (e.g., “back-offs”). The amount of back-off may vary based upon a measured or predicted RF transmission power for the wireless communication in accordance with the attenuation function that is applied. In an implementation, the mobile computing device may also be configured to report SAR data to a base station to enable the base station to determine back-offs on behalf of the device or otherwise manage communication services based at least in part upon knowledge of operational conditions of the mobile computing device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ the techniques described herein.

FIG. 2 is a flow diagram that describes an example procedure in which a variable back-off for SAR compliance is identified in dependence upon an attenuation function established for a mobile computing device.

FIG. 3 is a flow diagram that describes an example procedure in which a RF transmission power back-off is computed based upon operational conditions of a device.

FIG. 4 is a flow diagram that describes an example procedure in which RF transmission power back-off values are pre-computed according to the functional relationship that is established. This may involve configuring a device to use one or more pre-computed tables.

FIG. 5 illustrates an example system including various components of an example device that can be implemented as any type of computing device as described with reference to FIGS. 1-4 to implement techniques described herein.

### DETAILED DESCRIPTION

### Overview

One challenge faced by mobile computing device designers is adherence to Specific Absorption Rate (SAR) limits that are established in relation to radio frequency (RF) emissions by mobile devices. A traditional solution involves setting a fixed maximum RF transmit power across all communication hardware, however, this approach generally sets a cautiously low maximum to maintain compliance at the expense of communication connection performance and/or quality.

Radio Frequency (RF) attenuation function techniques are described for intelligently modifying the performance of radio devices to maintain specific absorption rate (SAR) compliance with regulatory requirements while minimally perturbing antennas/radio operations. In one or more implementations, a mobile computing device is configured to implement attenuation functions to maintain compliance. The attenuation functions reflect relationships established between transmission power and RF back-off for different operational contexts. The operational context may depend upon multiple factors such as the radio access technology (RAT) employed, RF band, RF frequency, device identity or type, number and kinds of antennas in operation, and so forth. Rather than setting a fixed back-off for power reductions across different operational conditions and/or devices, an appropriate attenuation function that matches an operational context for a wireless communication in which a device is engaged may be selected and applied to make variable adjustments to RF power (e.g., “back-offs”). The amount of back-off may vary based upon a currently measured or predicted RF transmission power for the wireless communication in accordance with the attenuation function that is applied. Moreover, the attenuation function applied may be specific to the device, RAT, frequency band, channel frequency and/or other factors used to define different operational contexts.

The mobile computing device may compute back-off values on-demand using the functions or may alternatively be configured to look-up pre-computed values from a table or other data structure. Individual devices may be programmed with a single device-specific (e.g., “default”) attenuation function or with a pre-computed device-specific table of values that is used to obtain back-off values to apply in different scenarios. Alternatively, the mobile computing device may be configured to make use of multiple functions or tables corresponding to different operational contexts of the device, in which case the mobile computing device may make selections from among the different available functions/tables based on an operational context associated with a current wireless communication. In an implementation, the mobile computing device may also be configured to interact with a base station to identify a back-off value to apply that is determined by the base station on behalf of the mobile computing device.

In the following discussion, an example environment and devices are first described that may employ the techniques described herein. Example details and procedures are then described which may occur in the example environment and by the devices as well as in other environments and by other devices. Consequently, the example details and procedures are not limited to the example environment/devices and the example environment/devices are not limited to performance of the example details and procedures.

### Example Operating Environment

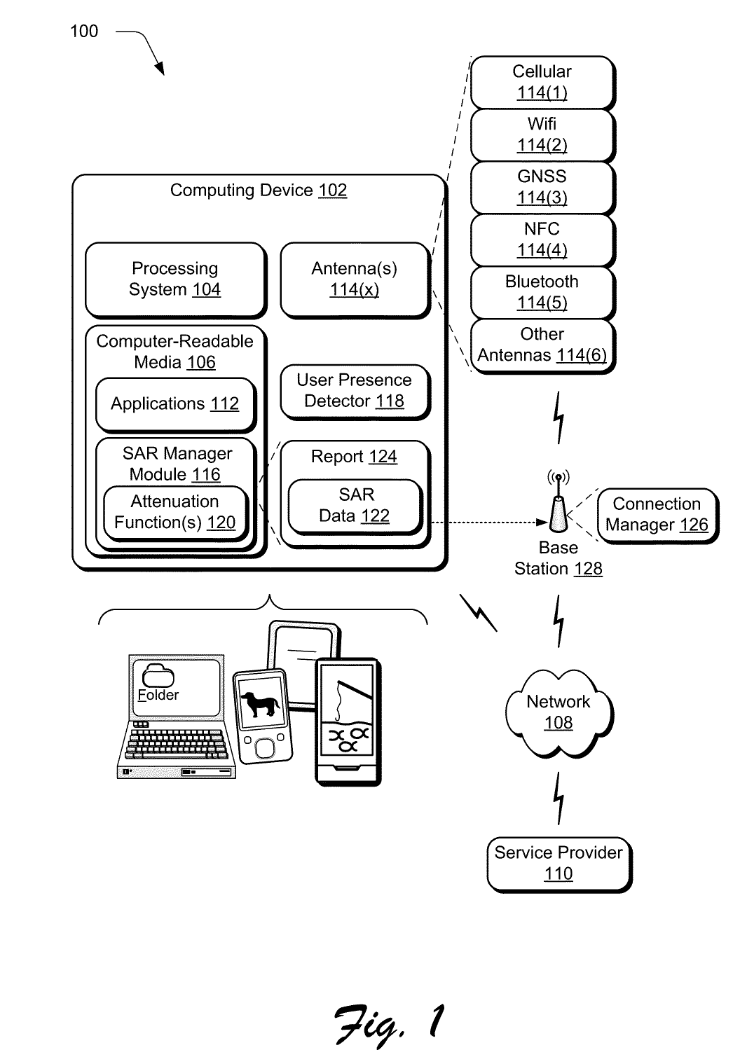

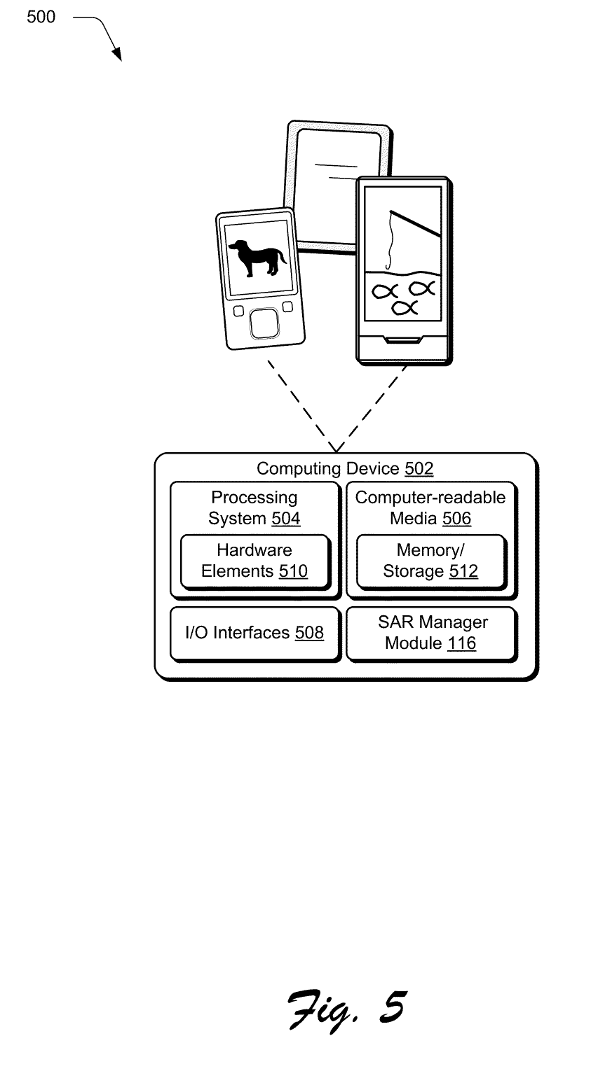

FIG. 1 is an illustration of an environment 100 in an example implementation that is operable to employ the techniques described herein. The illustrated environment 100 includes an example of a computing device 102 that includes a processing system 104 and computer-readable media 106 that are representative of various different types and combinations of processing components, media, memory, and storage components and/or devices that may be associated with a computing device and employed to provide a wide range of device functionality. In at least some embodiments, the processing system 104 and computer-readable media 106 represent processing power and memory/storage that may be employed for general purpose computing operations. More generally, the computing device 102 may be configured as any suitable computing system and/or device that employ various processing systems and computer-readable media to implement functionality described herein, additional details and examples of which are discussed in relation to the example computing system of FIG. 5.

The computing device 102 may be configured in a variety of ways. For example, the computing device 102 may be configured as a mobile computing device for mobile use as illustrated, such as a mobile phone, a tablet computer, a laptop, a portable media device, and so on. The computing device 102 may range from full resource devices with substantial memory and processor resources to a low-resource device with limited memory and/or processing resources. The computing device 102 may also relate to software that causes the computing device 102 to perform one or more operations.

The computing device 102 may further be communicatively coupled over a network 108 to a service provider 110. The service provider 110 may be configured to make various resources (e.g. content and services) available over the network 108 to the computing device 102 and other clients. Generally, resources made accessible by a service provider 110 may include any suitable combination of services and/or content typically made available over a network by one or more providers. Some examples of services include, but are not limited to, cellular communication service, Internet data service, navigation service, a search service, an email service, an instant messaging service, an online productivity suite, and an authentication service to control access of clients to the resources, to name a few examples. Content may include various combinations of text, multi-media streams, documents, application files, photos, audio/video files animations, images, web pages, web applications, device applications, content for display by a browser or other client application, and the like.

As further illustrated in FIG. 1 the computing device 102 may include various applications 112, one or more antennas 114(x) to provide various wireless communication functionality, a SAR manager module 116 operable to control the antennas for SAR compliance, and one or more user presence detectors 118 to supply user presence indications and/or user proximity measurements with respect to the antennas. A variety of applications 112 that provide different functionality to the device may be provided on some form of computer-readable media and may be executed via the processing system. Some examples of applications 112 typically associated with computing devices include, but are not limited to, an operating system, a productivity suite that integrates multiple office productivity modules, a web browser, games, a multi-media player, a word processor, a spreadsheet program, a photo manager, and so forth.

The one or more antennas 114(x) are representative of various antennas employed by the computing device to implement wireless functionality, subsystems, and communications. In accordance with techniques described herein, the antennas may include multiple different kinds of antennas (e.g., radios) that are arranged together within one or more antennas zones established for the computing device. In general, the antennas may be placed to minimize interference between antennas and/or achieve performance objectives for the suite of antennas as a whole. A variety of different types of antennas, combinations of different types of antennas, and arrangements of antennas are contemplated. For example, the antennas 114(x) may include one or more cellular 114(1) antennas, Wi-Fi 114(2) antennas, global navigation satellite system (GNSS) 114(3) antennas, Near Field Communication (NFC) 114(4) antennas, Bluetooth 114(5) antennas, and/or other 114(6) antennas. In accordance with techniques described herein, the antennas 114 may include multiple antennas that may be interdependent upon one another and/or are arranged/designed in combination. In some scenarios, some wireless technologies may be implemented using two or more individual radios/antennas.

For instance, the Wi-Fi 114(2) antennas may employ a two-by-two multiple input/multiple output configuration (e.g., 2×2 MIMO). The Wi-Fi antennas may include at least a main and a MIMO antenna in some configurations. In addition, a Bluetooth 114(5) antenna may optionally be combined with the Wi-Fi 114(2) antennas. Further, modern cellular technologies such as Long Term Evolution (LTE), WiMax, and/or 4G may employ two or more cellular 114(1) antennas, such as a main cellular antenna and a MIMO cellular antenna and cover various frequencies, bands, geographic areas, and so forth. The GNSS 114(3) antennas may be configured for use with various types of navigation standards, technologies, and systems including but not limited to GPS, GLONASS, Galileo, and/or BeiDou navigation systems, to name some examples. A variety of different combinations of antennas including the example antennas as well as other types of antennas are contemplated.

The SAR manager module 116 represents functionality operable to implement an optimization scheme to control antennas 114(x) to maintain SAR compliance in various scenarios. For example, the SAR manager module 116 may be configured to select and apply an attenuation function 120 to control transmission power for the antennas to comply with SAR requirements. Rather than using a fixed back-off, the attenuation function 120 is representative of a functional relationship between RF transmission power and back-off that is established for a particular operational context of the device. The attenuation function 120 may be utilized to compute back-off values to apply based upon at least a reference input value for RF transmission power. Other inputs to attenuation function 120 may be user proximity to antenna(s) 114(x), ambient conditions (e.g., temperature, humidity, etc.), or user preferences, which may be used to increase or decrease back-off based on a stored user-preference indicative of a user's preference for increased back-off beyond that required to comply with a jurisdiction's SAR regulations.

Different attenuation functions 120 may be derived for different operational contexts. This may occur as part of device development and testing. For instance, relationships between RF transmission power and back-off may be determined under various conditions by applying curve fitting techniques to data sets for radiation exposure at various transmission power levels obtained through empirical testing. Generally, the amount of back-off sufficient to maintain SAR compliance decreases as the RF transmission power level decreases. For some devices and operational contexts, an attenuation function may reflect a linear approximation and/or first degree polynomial expression of the relationship between RF transmission power and back-off for a range of transmission powers. Non-linear relationships, such as second degree and higher order polynomial approximations that define curves are also contemplated. An attenuation function 120 may also be a continuous function or discontinuous function across RF transmission power levels in the range of interest. For example, a discontinuous combination of multiple linear and/or non-linear approximations that fit different ranges of the empirical data may be used to define an attenuation function 120 under some conditions. A piecewise linear function may be used to define all or part of an attenuation function 120. Different functional relationships may therefore be used in combination for different portions of the same range of transmission powers. Accordingly, a linear approximation may be employed for the entire range is some cases or at least a portion of the range of transmission in other cases in which discontinuous combinations of functions are used to characterize the relationship. Likewise, a non-linear approximation may be also employed for the entire range or a portion of the range of transmission values.

The SAR manager module 116 may be configured to include or make use of one or more different attenuation functions 120 that are applicable to the different operational contexts. In brief, different operational contexts may be defined for different combinations of factors that may affect RF transmissions including but not limited to Radio Access Technology (RAT) (e.g., CDMA, GSM, LTE, 4G, etc.) employed, RF band, channel frequency, number and type of antennas being used, wireless interactions between multiple antennas, device identity or type, device capabilities, user presence indications, and so forth. Accordingly, a library of multiple attenuation functions 120 that may be used across many different devices may be derived for a plurality of operational contexts. The attenuation functions 120 may be established on a per RAT, band, and/or channel frequency basis, such that different attenuation functions are associated with different RATs, bands, and/or channel frequencies. More generally, each attenuation function corresponds to a particular operational context that is characterized by a combination of various factors that may affect RF transmissions, including but not limited to the example factors enumerated above. Each individual device may have access to the library of attenuation functions 120 or alternatively may be programmed with one or more “default” and/or device-specific attenuation functions 120 that are specific to the device.

The SAR manager module 116 may operate to apply an appropriate attenuation function 120 to control transmission power in response to conditions that may violate SAR requirements in the absence of attenuation. This may include identifying a current operational context of the device and selecting a corresponding attenuation function 120 that matches the operational context from multiple available options. Alternatively, a single device-specific attenuation function may be utilized in which case the SAR manager module 116 may be configured to compute back-off values on-demand using the device-specific attenuation function. Back-off values may be pre-computed across a range of transmission power levels using the attenuation functions and stored in a table or other data structure that is included with, or otherwise accessible for use by, the SAR manager module 116. Accordingly, identifying a back-off value to apply in a given scenario may involve performing a look-up on pre-computed back-off values using a transmission power level value as a reference value for the look-up.

The SAR manager module 116 may be implemented in various ways including but not limited to being provided as a standalone software module, firmware of one or more antennas/communication subsystems, a software component of an operating system or other application 112 (e.g., an antenna performance and communication manager application), as a hardware logic device, a fixed or programmable logic circuit, a hardware component of a system-on-chip (SoC), and so forth. In accordance with techniques described herein, the SAR manager module 116 may be configured to use an appropriate attenuation function 120 to select and apply variable back-offs that may be determined based upon a plurality of considerations.

For example, a variable amount of RF transmission power reduction may be selected in response to a trigger based upon a user presence indication in combination with an operational context that is determined for a device. In particular, a selected and/or device-specific attenuation function 120 may be applied to set the RF transmission power reduction in various scenarios. The amount of power reduction applied may be selected according to the attenuation function 120 that is dependent at least partially upon the operational context, rather than merely user presence alone. This is in contrast to traditional techniques that employ fixed back-offs at pre-set levels that are either turned on or off in a binary manner when triggered by user presence or otherwise.

To control antenna operations, the SAR manager module 116 may be configured to obtain user presence indications from user presence detectors 118. The user presence detectors 118 are representative of suitable hardware, software, firmware, logic and combinations thereof to obtain user presence indications and to supply such information for use by the SAR manager module 116. A variety of different physical sensors, sensor arrangements, and techniques for the user presence detectors 118 may be employed.

For example, a user presence detector 118 may be configured as a hardware sensor capable of detecting and indicating presence of a user relative to the computing device and/or relative to particular regions of the device for which SAR mitigation is relevant. User presence detector 118 may be configured to measure the distance from a user to the computing device. Generally, a user presence detector 118 may be located proximate to antennas 114(x) to indicate when a user is positioned in a manner relative to the antennas that would increase or decrease the likelihood of exceeding SAR limits. For instance, placing a hand over a region having one or more of the antennas to hold a device may increase the amount of RF energy that the user is exposed to. On the other hand, some device hand positions for holding a device may be at a sufficient distance from the antennas to reduce exposure and permit higher RF energy outputs without causing SAR violations. Further, SAR compliance may depend in general upon whether or not a user is physically interacting with the device and the context of interaction.

Thus, if the device is set down to watch a media presentation or placed on a table after use, the level of potential exposure decreases. User actions with a device such as typing, gestures, selecting buttons, and other types of input may be indicative of user presence. These and other contextual factors regarding usage of the device may be considered along with information obtained directly from user presence detectors 118 to determine when and how to trigger and adjust antenna output. By way of example, user presence detectors 118 employed by a device may include but are not limited to capacitive sensors, infrared radiation (IR) sensors, pressure sensors, optical detectors, a camera, sensors for measuring reflected RF radiation from the antennas 114(x), and/or other type of sensors capable of determining a relationship of a user relative to the device and supplying such information as user presence indications.

In addition to implementing the attenuation functions 120 to control antennas and mitigate SAR exposure, the SAR manager module 116 may be further configured to initiate reporting of data describing SAR related conditions and actions to other entities to facilitate management of connections of the device to access services associated with one or more service providers 110. To do so, the SAR manager module 116 may generate SAR data 122 in a suitable format for inclusion in a report 124 for communication to a connection manager 126.

The connection manager 126 represents functionality operable to facilitate management of connections of the computing device 102 via the antennas 114(x) to corresponding services and service providers. This may include but is not limited to opening/closing connections, client authentication, providing access to data and resources, setting data rates, controlling communication quality, handling hand-offs between access points, routing operations, and so forth. In at least some implementations, the connection manager 126 is configured to utilize SAR data 122 supplied in reports 124 from devices to manage connections of the devices in a manner that takes SAR related conditions and activities of the devices into account.

In other words, connection management operations performed by the connection manager 126 may be informed by and/or selected in dependence upon SAR data 122 supplied by devices. The connection manager 126 may be implemented as a component of a base station 128 associated with a cellular network, Wi-Fi network, a satellite network, or other network as represented in FIG. 1. The base station 128 is therefore representative of any suitable wireless network access point through which antennas 114(x) may gain access to corresponding services, such as a cellular tower/cellular base station, a Wi-Fi access point, a wireless router, a satellite network satellite, or other base station device.

In an implementation, the connection manager 126 may be configured to use SAR data 122 supplied by a device to determine back-offs on behalf of the device. The SAR data 122 may provide an indication of the operational context as described herein, including at least data suitable to identify the device and a transmission power level. Based on the supplied SAR data 122, the connection manager 126 may operate to compute a back-off value using a corresponding attenuation function or look-up the back-off value from one or more tables maintained by the base station. To do so, the connection manager 126 may be configured to select a function or table that matches the device and/or operational context as indicated by the SAR data 122 and then determine the back-off using the selected function or table. The connection manager 126 may then communicate an indication of the determined back-off level back to the device to enable the device to apply the back-off to maintain compliance. In this approach, the base station is used to offload processing and storage requirements related to determining SAR back-offs from mobile devices that may have limited capabilities in comparison to the base station. Offloading the processing and storage of data to the base station may free-up resources of the mobile computing device for other tasks. As a result, the mobile computing device is able to direct more resources towards core communication functionality, which may reduce latency and improve the quality of communications.

Having discussed an example environment and devices, consider now some example details regarding RF attenuation functions for SAR compliance in accordance with various implementations.

### Radio Frequency (RF) Attenuation Functions

The following discussion presents some details regarding RF attenuation functions for SAR compliance in relation to some illustrative procedures. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. Aspects of the described procedures may be implemented by one or more suitably configured computing devices individually or in combination, such as a computing device 102 of FIG. 1 that includes a SAR manager module 116 and/or a base station 128 device that implements a connection manager 126.

Functionality, features, and concepts described in relation to the examples of FIG. 1 may be employed in the context of the procedures described herein. Further, functionality, features, and concepts described in relation to different procedures below may be interchanged among the different procedures and are not limited to implementation in the context of an individual procedure. Moreover, blocks associated with different representative procedures and corresponding figures herein may be applied together and/or combined in different ways. Thus, individual functionality, features, and concepts described in relation to different example environments, devices, components, and procedures herein may be used in any suitable combinations and are not limited to the particular combinations represented by the enumerated examples.

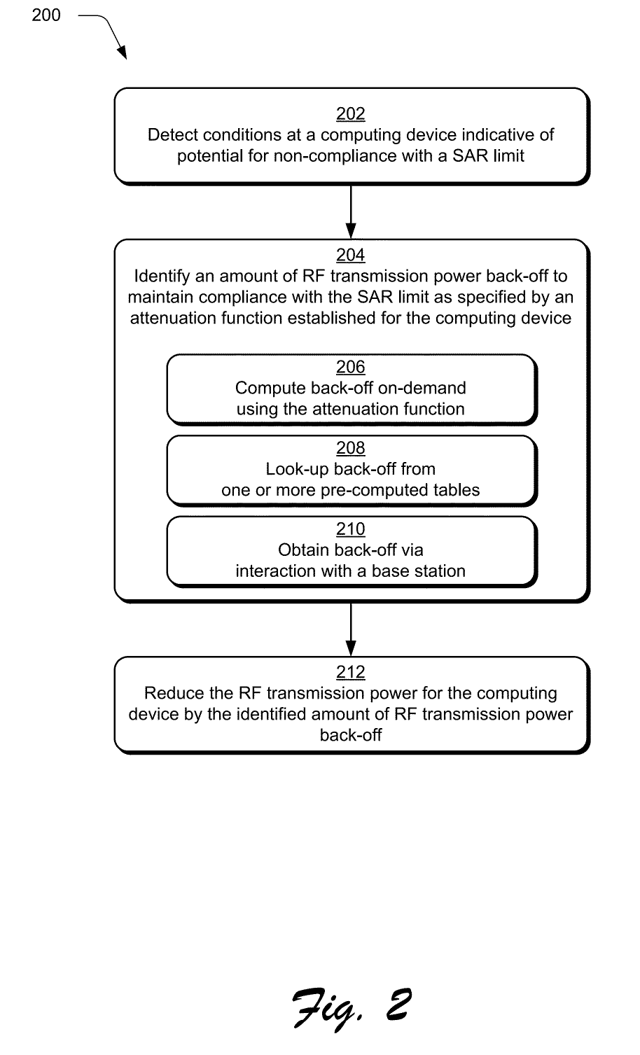

FIG. 2 depicts an example procedure 200 procedure in which a variable back-off for SAR compliance is identified in dependence upon an attenuation function established for a computing device. Conditions are detected at a computing device that are indicative of potential for non-compliance with a specific absorption rate (SAR) limit (block 202). The detected conditions may include indications of user presence with respect to one or more antennas 114(x). The indications of user presence may be determined using information from one or more user presence detectors 118. Generally, user presence detectors 118 may be placed within or proximate to a portion of a device that houses antennas and/or in relation to individual antennas to detect when a user is “present.” The presence of a user in the context of SAR mitigation refers to whether the relationship of the user to a device encroaches upon the antennas to an extent that potential for the user to be exposed to RF emissions above SAR limits is increased to an unacceptable level. A user may be considered present under conditions that increase potential exposure to unacceptable levels and considered not present when the user is sufficiently removed from the antennas. Presence may be indicated for different antennas or groups of antennas of a device on an individual basis. Thus, a user may be considered present with respect to some antennas and at the same time considered not present with respect to other antennas of a particular device. In addition or alternatively, other conditions may also be detected that provide contextual clues regarding whether or not a user is at risk for excessive SAR exposure. Presence with respect to SAR compliance may depend in general upon whether or not a user is physically interacting with the device and the context of interaction. Thus, if the device is set down to watch a media presentation or placed on a table after use, the level of potential exposure decreases. User actions with a device such as typing, gestures, selecting buttons, and other types of input may also be indicative of user presence. These and other contextual factors regarding usage of the device may be detected as conditions used along with information obtained directly from user presence detectors 118 to determine when and how to adjust antenna output.

An amount of RF transmission power back-off to maintain compliance with the SAR legal limit is identified as specified by an attenuation function established for the computing device (block 204). The amount of RF transmission power back-off to apply under particular circumstances may be identified in various ways. Generally, the SAR manager module 116 makes a determination of the back-off based upon an attenuation function 120 that corresponds to the device and/or a particular operational context in which the device is being operated. The amount of RF transmission back-off also depends upon a RF transmission power level for the mobile computing device as described previously. Accordingly, an attenuation function employed for a particular operational context is configured to reflect a functional relationship between transmission power level and back-off across a range of transmission power levels for the operational context.

By way of example, the SAR manager module 116 may be configured to identify an amount of back-off based upon an attenuation function by computing the back-off on-demand using an appropriate attenuation function (block 206) and/or a look-up of the back-off from one or more pre-computed tables (block 208). In addition or alternatively, the back-off may be obtained via interaction with a base station (210) to cause the base station to make a determination of the back-off on behalf of the mobile computing device. For instance, a connection manager 126 of a base station 128 may compute or look-up a back-off amount and supply an indication of the back-off amount to a mobile computing device in response to a request to initiate the determination. The request may be configured to contain SAR data 122 that enables the base station 128 to make the determination of back-off on behalf of the device.

An attenuation function that is used to directly compute the back-off at the device or by a base station may be selected from multiple available options based upon a current operational context. Alternatively, one or more pre-computed tables used to look-up back-off values may be produced in advance using attenuation functions for different operational contexts. The pre-computed tables may deployed to the device and/or base station to enable look-up of back-off amounts based upon a transmission power level and a particular operational context.

RF transmission power for the computing device is reduced by the identified amount of RF transmission power back-off (block 212). Here, the SAR manager module 116 operates to control one or more antennas 114(x) by reducing transmission power in accordance with the determined back-off. This reduction occurs responsive to conditions that indicate potential for SAR non-compliance, such as detection of user presence. Once SAR mitigation actions are triggered, the back-off is computed according to a particular attenuation function or pre-computed table based on the attenuation function that matches the operational context. Although, user presence may be a pre-condition to applying a back-off, the amount of back-off actually applied may be independent of a distance between the device and the user. As such, complexity associated with monitoring and using a distance factor as part of the computation of back-off may be avoided.

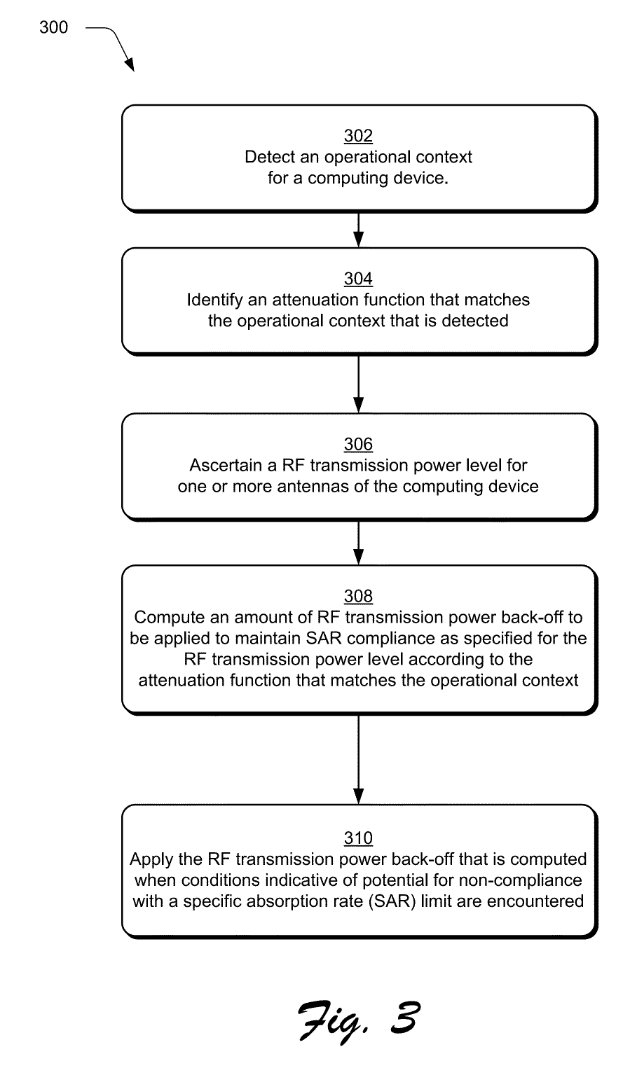

FIG. 3 is a flow diagram that describes an example procedure 300 in which a RF transmission power back-off is computed based upon operational conditions of a device. An operational context for a computing device is detected (block 302). For instance, the SAR manager module 116 may be configured to detect an operational context for device communications in any suitable way. In one or more implementations, the SAR manager module 116 may monitor ongoing communications to understand contextual factors for the communication such as RAT, band, frequency and/or other factors that may be used to define different operational contexts. The SAR manager module 116 may match conditions/factors determined for ongoing communications to factors that specify different operational contexts. By way of example, if a cellular communication occurs using CDMA technology and a particular channel frequency, the SAR manager module 116 may recognize these conditions and match the cellular communication to a corresponding operational context. A variety of other examples are also contemplated.

An attenuation function is identified that matches the operational context that is detected (block 304). As noted, different attenuation functions may be established for different operational contexts. Thus, once the SAR manager module 116 determines a current context, this knowledge may be used to find an attenuation function that matches the detected operational context. In one approach, the SAR manager module 116 may include or make use of a library of attenuation functions that may be referenced based on operational context. The library may be configured as a global library that may be used across different devices or a device-specific library that contains one or more attenuation function that match a set of operational contexts attainable by the device. In an implementation, operation of the device may be characterized by a single attenuation function in which case the SAR manager module 116 may be configured to access and use the single attenuation function for back-off computations.

An RF transmission power level is ascertained for one or more antennas of the computing device (block 306). The SAR manager module 116 may determine a power level RF transmission power level for a device in any suitable way. In one approach, transmission power may be measured via power monitoring circuitry incorporated with hardware of particular radios/antennas. In addition or alternatively, a computing device 102 may be configured to include a monitoring device having a power detector circuit designed to monitor RF levels of one or more corresponding antennas. Here, the transmission power level used to determine back-off may be a measured, current transmission power level.

In one or more implementations, the back-off determination may also be performed based upon a predicted transmission power level for a future time period. For example, in cellular communications transmission power for successive transmission slots may change as a position of the device changes relative to base stations and other components of the network infrastructure. Here, the SAR manager module 116 may be configured to predict future communication conditions and pre-compute a back-off that is appropriate for those future conditions. To do so, the SAR manager module 116 may implement a prediction model that may be used along with measured and detected conditions to drive SAR mitigation analysis and actions.

The prediction model may be configured in various ways to provide predictions of expected signal conditions including predictions for expected transmission power levels of one or more antennas. In particular, the model may designed to account for a plurality of factors to generate predictions for an expected transmission power level of a particular antenna at a given time. For example, the model may account for one or more of historical analysis of connection traffic, usage and travel patterns for individual devices, network topology, base station arrangement and coverage grids, information regarding coverage overlaps, historic bandwidth metrics, device and base station capabilities, and/or other factors that facilitate predictions of expected changes in transmission power based on signal conditions within the network. Statistical analysis and/or weighted combinations of these and other factors may be used to create a model that indicates when changes to transmission power are likely to occur and the amount of drop or increase expected. Predictions derived via the model may then be used to inform decisions regarding whether to take action in response to a SAR triggering event and what action to take. For example, a predicted transmission power level may be used to compute or look-up a back-off amount for an upcoming communication slot.

An amount of RF transmission power back-off to be applied to maintain SAR compliance is computed as specified for the RF transmission power level according to the attenuation function that matches the operational context (block 308) and the RF transmission power back-off that is computed is applied when conditions indicative of potential for non-compliance with a specific absorption rate (SAR) limit are encountered (block 310). For example, a measured or predicted RF transmission power level may be provided as reference input to a selected attenuation function to compute a back-off on-demand. The computed back-off is determined according to a functional relationship reflected by the chosen attenuation function. A variety of different functions and functional relationships are contemplated, some examples of which were discussed above in relation to FIG. 1. Naturally, because different attenuation functions may be associated with different operational contexts, the functional relationship and amount of back-off computed may change for different operational contexts.

The back-off may be applied to maintain compliance responsive to conditions indicative of potential for non-compliance, such as when user presence is detected based on a user presence detector 118 and/or contextual factors indicative of user interaction with a device. The back-off for a given transmission power level may be determined responsive to change in power level and independently of user presence. In other words, back-off amounts may be predetermined for each power level and then applied in response to an event that triggers mitigation. Alternatively, the computation of back-off may occur responsive to detection of user presence or another mitigation trigger.

Note that a SAR manager module 116 may be configured to make use of pre-computed tables in addition to or in lieu of using attenuation functions to compute back-off on demand. Thus, although the example procedure 300 is described in the context of using attenuation functions to directly compute back-off amounts, a comparable procedure may be employed to look-up back-off amounts from one or more pre-computed tables that are derived from corresponding attenuation functions. In this approach, an appropriate pre-computed table that matches an operational context detected in accordance with block 302 may be identified. A measured or predicted RF transmission power level as determined in accordance with block 306 may then be used to look-up a corresponding back-off from the pre-computed table that matches the operational context.

As with the attenuation functions, the SAR manager module 116 may include or make use of a library of pre-computed tables that may be referenced based on operational context. The library may be configured as a global library that may be used across different devices or a device-specific library that contains one or more pre-computed tables that match a set of operational contexts attainable by the device. In an implementation, operation of the device may be characterized by a single attenuation function in which case the SAR manager module 116 may be configured to access and use a single pre-computed table derived from the attenuation function for back-off computations.

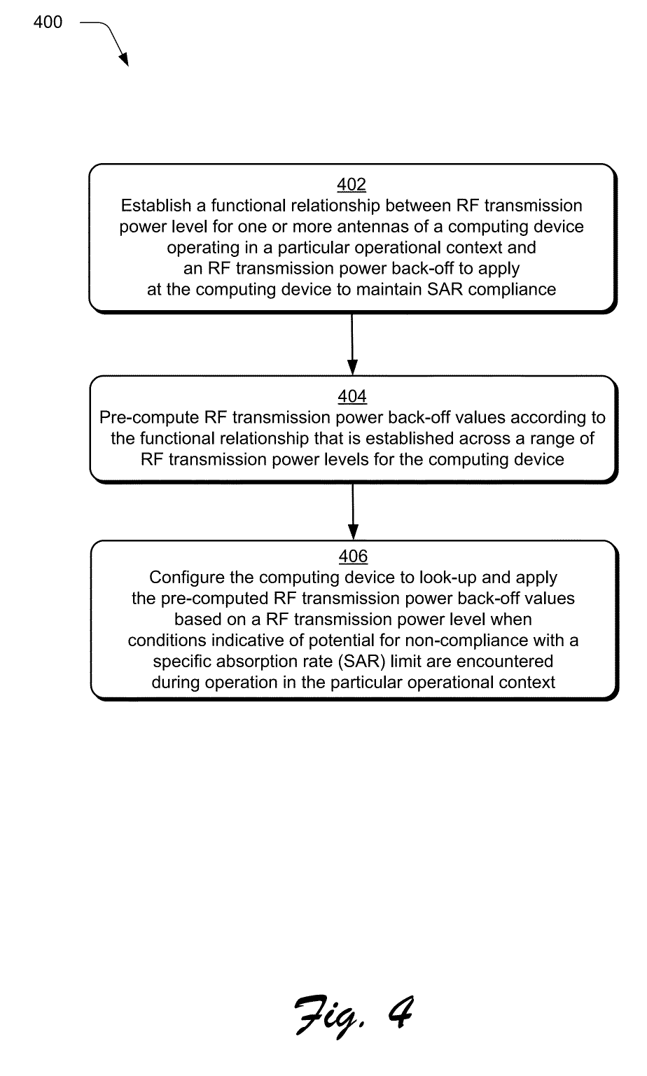

FIG. 4 is a flow diagram that describes an example procedure 400 in which RF transmission power back-off values are pre-computed according to the functional relationship that is established. This may involve configuring a device to use one or more pre-computed tables derived from attenuation functions for different operational contexts. In particular, a functional relationship is established between RF transmission power level for one or more antennas of a computing device operating in a particular operational context and an RF transmission power back-off to apply at the computing device to maintain SAR compliance (block 402). For example, empirical testing of mobile computing devices may be conducted to obtain data indicative of back-offs across a range of RF transmission power levels for the device. Each different device type or model may be tested and the testing of each individual device may span different operational contexts, which may be defined in the manner previously described. For example, testing of a device may occur for each RAT, RF band and/or channel frequency under which the device may operate. Moreover, testing may occur for multiple combinations of RAT, RF band, channel frequency and other factors that affect transmissions. Accordingly, functional relationships established based on such testing may depend upon the operational context and different relationships may be established for different operational contexts, as well as for different device types/models.

In an implementation, data sets obtained through the empirical testing may be characterized using curve fitting techniques to match the data sets to appropriate attenuation functions. As discussed previously, linear or non-linear functions may be used individually or in combinations to approximate the functional relationships for different operational contexts, as well as for different device types/models.

Having established the relationship under a particular operational context, RF transmission power back-off values are pre-computed according to the functional relationship that is established across a range of RF transmission power levels for the computing device (block 404). For example, a pre-computed table, data file, or other suitable data structure may be generated that contains back-off values computed for a range of RF transmission power levels. The range of RF transmission power levels for which corresponding back-off values are pre-computed may contain a minimum transmission power level, a maximum transmission power level, and one or more intermediate transmission power level(s). In one or more implementations, three or more points indicated by the functional relationship that is established may be pre-computed. Naturally, the pre-computed values are also associated with the particular operational context. Moreover, for devices that operate under multiple different operational contexts, multiple corresponding sets of pre-computed back-off values may be generated.

The computing device is configured to look-up and apply the pre-computed RF transmission power back-off values based on a RF transmission power level when conditions indicative of potential for non-compliance with a specific absorption rate (SAR) legal limit are encountered in the particular operational context (block 406). For example, a SAR manager module 116 as described herein may be implemented by a mobile computing device in hardware, software, firmware or combinations thereof. The SAR manager module 116 may be configured to include or otherwise make use of pre-computed RF transmission power back-off values in various ways. For example, one or more pre-computed tables that relate back-off values to RF transmission power for different operational contexts may be installed at a computing device as components of the SAR manager module 116 or as standalone components that are accessible to the SAR manager module 116. In addition or alternatively, one or more pre-computed tables may be accessible from a remote location such as via a base station or other network service provider.

Further, the SAR manager module 116 may operate to determine when potential for non-compliance with SAR exists. A measured or predicted RF transmission power level may then be used as a reference transmission power level to look-up a corresponding back-off from power back-off values maintained in a table at the device, by the base station, or at another location accessible to the SAR manager module 116. This may involve looking up values from a table or other data structure that corresponds to a current operating context under which the mobile computing device is being operated. A back-off value determined based on the look-up may then be applied by SAR manager module 116 to reduce transmission power of one or more antennas of a mobile computing device and thereby maintain compliance with SAR limits.

Having considered the foregoing example procedures, consider now a discussion of example systems and devices that may be employed to implement aspects of techniques in one or more embodiments.

### Example System and Device

FIG. 5 illustrates an example system generally at 500 that includes an example computing device 502 that is representative of one or more computing systems and/or devices that may implement the various techniques described herein. The computing device 502 may, for example, be configured to assume a mobile configuration through use of a housing formed and size to be grasped and carried by one or more hands of a user, illustrated examples of which include a mobile phone, mobile game and music device, and tablet computer although other examples are also contemplated.

The example computing device 502 as illustrated includes a processing system 504, one or more computer-readable media 506, and one or more I/O interface 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 506 is illustrated as including memory/storage 512. The memory/storage 512 represents memory/storage capacity associated with one or more computer-readable media. The memory/storage component 512 may include volatile media (such as random access memory (RAM)) and/or nonvolatile media (such as read only memory (ROM), Flash memory, optical disks, magnetic disks, and so forth). The memory/storage component 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 502 may be configured in a variety of ways to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the modules and techniques described herein, including but not limited to the SAR manager module 116 (as shown) and connection manager 126, may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” may refer to media and/or devices that enable storage of information in contrast to mere signal transmission, carrier waves, or signals per se. Thus, computer-readable storage media does not include signal bearing media or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, microcontroller devices, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable media described previously.

Combinations of the foregoing may also be employed to implement various techniques described herein. Accordingly, software, hardware, or executable modules may be implemented as one or more instructions and/or logic embodied on some form of computer-readable media and/or by one or more hardware elements 510. The computing device 502 may be configured to implement particular instructions and/or functions corresponding to the software and/or hardware modules. Accordingly, implementation of a module that is executable by the computing device 502 as software may be achieved at least partially in hardware, e.g., through use of computer-readable media and/or hardware elements 510 of the processing system 504. The instructions and/or functions may be executable/operable by one or more articles of manufacture (for example, one or more computing devices 502 and/or processing systems 504) to implement techniques, modules, and examples described herein.

### CONCLUSION

Although the example implementations have been described in language specific to structural features and/or methodological acts, it is to be understood that the implementations defined in the appended claims are not necessarily limited to the specific features or acts described. Rather, the specific features and acts are disclosed as example forms of implementing the claimed features.

What is claimed is:

1. A method comprising:
detecting conditions at a computing device indicative of potential for non-compliance with a specific absorption rate (SAR) limit;
identifying an amount of radio frequency (RF) transmission power back-off to maintain compliance with the SAR limit as specified by an attenuation function established for the computing device; and
reducing the RF transmission power for the computing device by the identified amount of RF transmission power back-off.

2. A method as described in claim 1, wherein the attenuation function reflects a relationship between transmission power back-off and RF transmission power level across a range of RF transmission power levels for the computing device.

3. A method as described in claim 2, wherein the attenuation function comprises a linear approximation of the relationship between transmission power back-off and RF transmission power level across at least a portion of the range of RF transmission power levels.

4. A method as described in claim 2, wherein the attenuation function comprises a non-linear approximation of the relationship between transmission power back-off and RF transmission power level across at least a portion of the range of RF transmission power levels.

5. A method as described in claim 1, wherein the amount of transmission power back-off is identified based upon a measured RF transmission power level for one or more antennas of the computing device.

6. A method as described in claim 1, wherein the amount of transmission power back-off is identified based upon a predicted RF transmission power level for future communications of the computing device.

7. A method as described in claim 1, wherein identifying the amount of RF transmission power back-off to maintain compliance with the SAR limit as specified by the attenuation function comprises computing the RF transmission power back-off on-demand using the attenuation function.

8. A method as described in claim 1, wherein identifying the amount of RF transmission power back-off to maintain compliance with the SAR limit as specified by the attenuation function comprises looking up the RF transmission power back-off from one or more pre-computed tables.

9. A method as described in claim 1, wherein identifying the amount of RF transmission power back-off to maintain compliance with the SAR limit as specified by the attenuation function comprises obtaining an indication of the RF transmission power back-off via interaction with a base station configured to determine the RF transmission power back-off on behalf of the computing device.

10. A method as described in claim 1, wherein detecting the conditions indicative of potential for non-compliance with SAR limit comprises detecting presence of a user via one or more user presence detectors of the computing device.

11. A method as described in claim 1, wherein the attenuation function that is established for the computing device is specific to one or more of: a radio access technology (RAT), a frequency band, or channel frequency employed by the computing device for wireless communications.

12. A method as described in claim 1, wherein identifying the amount of RF transmission power back-off comprises:
detecting an operational context for the computing device;
identify an pre-computed table of back-off values associated with RF transmission power levels that is computed according to the attenuation function, the attenuation function corresponding to the operational context that is detected; and
looking-up the amount of RF transmission power back-off from the pre-computed table according to a reference RF transmission power level for one or more antennas of the computing device.

13. A computing device comprising:
one or more antennas configured to provide wireless communication functionality;
a specific absorption rate (SAR) manager module implemented at least partially in hardware and operable to:
detect an operational context for the computing device;
identify an attenuation function that matches the operational context that is detected;
ascertain a radio frequency (RF) transmission power level for one or more antennas of the computing device; and
compute an amount of RF transmission power back-off to be applied to maintain SAR compliance as specified for the RF transmission power level according to the attenuation function that is identified.

14. The computing device as described in claim 13, wherein the SAR manager module is further operable to apply the RF transmission power back-off that is computed when conditions indicative of potential for non-compliance with a SAR limit are encountered.

15. The computing device as described in claim 13, wherein the operational context is defined according to a combination of factors that affect RF transmissions including one or more of: Radio Access Technology (RAT), RF band, or channel frequency employed by the computing device.

16. The computing device described in claim 13, wherein:
the SAR manager module is configured to utilize a library of different attenuation functions corresponding to the different operational contexts; and
the attenuation function that is identified and used to compute the amount of RF transmission power back-off is selected from the library of different attenuation functions as matching the operational context that is detected.

17. The computing device described in claim 13, wherein the one or more antennas comprise at least one cellular antenna configured to enable connection of the computing device to cellular communication service via a base station.

18. A method comprising:
establishing a functional relationship between radio frequency (RF) transmission power level for one or more antennas of a computing device operating in a particular operational context and an RF transmission power back-off to apply at the computing device to maintain SAR compliance;
pre-computing RF transmission power back-off values according to the functional relationship that is established across a range of RF transmission power levels for the computing device; and
configuring the computing device to look-up and apply the pre-computed RF transmission power back-off values based on a RF transmission power level when conditions indicative of potential for non-compliance with a specific absorption rate (SAR) limit are encountered during operation in the particular operational context.

19. The method as recited in claim 18, wherein the range of RF transmission power levels for which corresponding back-off values are pre-computed contains a minimum transmission power level, a maximum transmission power level, and one or more intermediate transmission power levels.

20. The method as recited in claim 18, wherein establishing the functional relationship includes:
obtaining a data set indicative of back-offs across the range of RF transmission power levels; and
characterizing the data set using curve fitting to match the data set to a corresponding attenuation function that reflects the functional relationship.
